(19) United States
(12) Patent Application Publication
(10) Pub. No.: US 2024/0072504 A1
(43) Pub. Date: Feb. 29, 2024

(54) OPTICAL ASSEMBLY TO MODIFY NUMERICAL APERTURE OF A LASER BEAM

(71) Applicant: NLIGHT, INC., Camas, WA (US)

(72) Inventors: Aaron Brown, Vancouver, WA (US); Jay SMALL, Vancouver, WA (US); Kevin Michael CARBONE, Portland, OR (US); Stefano ORIGLIA, Turin (IT); Francesco PESCARMONA, Turin (IT)

(73) Assignee: NLIGHT, INC., Camas, WA (US)

(21) Appl. No.: 18/271,639

(22) PCT Filed: Jan. 10, 2022
(86) PCT No.: PCT/US2022/011859

§ 371 Date: Jul. 10, 2023

Related U.S. Application Data
(60) Provisional application No. 63/136,081, filed on Jan. 11, 2021.

(51) Int. Cl. H01S 3/00; G02B 27/30

(52) U.S. Cl. CPC H01S 3/005; G02B 27/30

(57) ABSTRACT

Some embodiments may include an optical assembly usable to process light output from a laser source. The apparatus may include a housing to receive a distal end of an optical fiber that outputs the laser light; one or more actively cooled or passively cooled beam traps contained within the housing or coupled to the housing; and one or more optical apertures located inside the housing, at least one of the optical apertures to define a numerical aperture (NA) of a first portion of the laser light based on a radial dimension of the at least one optical aperture, the at least one optical aperture arranged to pass the first portion of the light and redirect a second different portion of the laser light to the one or more actively cooled or passively cooled beam traps. Other embodiments may be disclosed and/or claimed.

### PRIORITY

The present application is a National Phase entry under 35 U.S.C. § 371 of International Application No. PCT/US2022/011859, filed on Jan. 10, 2022, which claims priority to U.S. Provisional Application No. 63/136,081, filed on Jan. 11, 2021, the entire contents of these applications are incorporated herein by reference in their entirety.

### TECHNICAL FIELD

The present disclosure relates to laser systems.

### BACKGROUND

Fiber lasers are widely used in industrial processes (e.g., cutting, welding, cladding, heat treatment, etc.) In some fiber lasers, the optical gain medium includes one or more active optical fibers with cores doped with rare-earth element(s). The rare-earth element(s) may be optically excited (“pumped”) with light from one or more semiconductor laser sources. There is great demand for high power and high efficiency diode lasers, the former for power scaling and price reduction (measured in $/Watt) and the latter for reduced energy consumption and extended lifetime.

### BRIEF DRAWINGS DESCRIPTION

The accompanying drawings, wherein like reference numerals represent like elements, are incorporated in and constitute a part of this specification and, together with the description, explain the advantages and principles of the presently disclosed technology.

FIG. 1 illustrates a schematic diagram of an optical assembly to modify a numerical aperture (NA) of a laser beam, according to various embodiments.

FIG. 2 illustrates a schematic diagram of an optical assembly to modify an NA of a laser beam in which the optical assembly is a collimation assembly, according to various embodiments.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items. The systems, apparatus, and methods described herein should not be construed as limiting in any way. Instead, the present disclosure is directed toward all novel and non-obvious features and aspects of the various disclosed embodiments, alone and in various combinations and sub-combinations with one another. The term “or” refers to “and/or,” not “exclusive or” (unless specifically indicated).

The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation. Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus.

Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art. In some examples, values, procedures, or apparatus' are referred to as “lowest”, “best”, “minimum,” or the like. It will be appreciated that such descriptions are intended to indicate that a selection among many used functional alternatives can be made, and such selections need not be better, smaller, or otherwise preferable to other selections.

Examples are described with reference to directions indicated as “above,” “below,” “upper,” “lower,” and the like. These terms are used for convenient description, but do not imply any particular spatial orientation.

Some fiber laser beams exhibit a high numerical aperture (NA) that prohibits use in many optical systems. Currently the extent of one such beam may approach or exceed NA 0.2, but many systems have lower NA requirements. Excess NA in an optical system can lead to overheating, misalignment, and damage to components.

In some embodiments, an optical assembly is provided to operate between a laser source and an optical system having an NA requirement different (e.g., lower) than the NA of a laser beam generated by the laser source. The optical assembly may include one or more aperture structures to clip the laser beam to strip out an NA range of light (e.g., damaging high-NA light). The optical assembly may include one or more passively or actively cool beam traps, and the aperture structure(s) may be arranged to pass a first portion of the laser beam and redirect a second portion of the laser beam to the passively or actively cooled beam trap(s).

In some embodiments, the optical assembly may provide an additional function—for instance the optical assembly may also be a collimation assembly. In these embodiments, the aperture structure(s) may be located upstream, downstream, or both from one or more lenses such as a collimating lens. In another embodiment, the optical assembly may not provide the additional function, e.g., the optical assembly may not contain any lenses and/or may be separate from a collimation assembly or may be modularly coupled to a collimation assembly.

In embodiments in which the optical assembly is a collimation assembly, for high power multimode fiber laser systems, the aperture may be built into the diverging portion of the assembly, directly downstream from the delivery fiber. High NA light may hit a reflective surface (e.g., a mirrored surface) and may be directed into a beam trap assembly that absorbs the light over many bounces. The geometry may keep the stripped-out light from re-entering the collimation path.

Various aperture geometries may be possible and practical. One example version may have a conical reflective surface (either reflectively convergent or divergent cone) and an annular beam trap chamber. Although a convergent cone may be easier to cool than a divergent cone option (sometimes referred as a knife-edge), some embodiments may use divergent cone options exclusively or in combination with convergent cones (e.g., a divergent cone may be used for a downstream aperture). Various optical apertures may be arranged to reflect like toward or away from an optical axis of the light beam, depending on the location of the beam trap.

In some embodiments, a cone may bounce the beam across the input path and into the beam dump chamber. The chamber features may be specifically designed to keep light from exiting once it has entered (e.g., a beam trap). The surfaces of the chamber may be plated to selectively reflect or absorb light, and the optical assembly may have heat dissipation features.

Heating of the structure of the optical assembly may result in thermal expansion, which may affect the sensitive spacing between an input fiber and the downstream optical elements. To counteract this effect, the aperture and beam dump assembly that defines the beam trap(s) may be produced with low expansion materials or in a manner that allows the heated material expansion not to affect the optical spacing.

For Single Mode fiber laser systems where the total laser power is below 2 kW, the excess NA power may be reduced to approximately 200 W. This may allow for a more compact stripping solution to maintain the form factor as collimators that currently serve the single mode laser market. Such collimators may already be configured for liquid cooling. In this case, reflective apertures may be used to redirect the high NA light into the collimator housing body's most efficient cooling region, typically between the fiber connector and the optical elements.

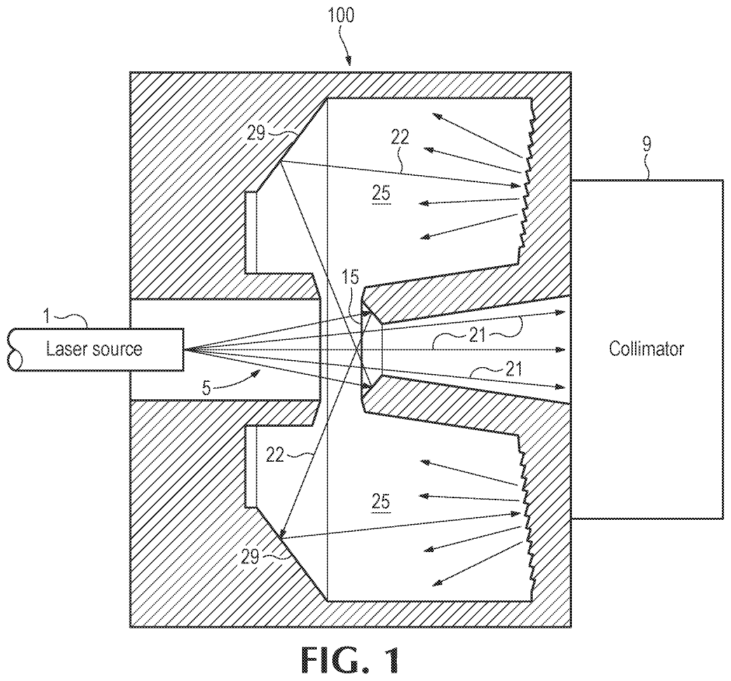

FIG. 1 illustrates a schematic diagram of an optical assembly 100 to modify a numerical aperture (NA) of a laser beam 5, according to various embodiments. The optical assembly 100 may include a housing coupled to a laser source 1 (e.g., coupled onto a distal end of a fiber laser or an optical fiber outputting laser light from some other laser source) or located proximate to the laser source 1 (e.g., mounted proximate to the distal end of the fiber laser on a mounting structure). The housing may also be coupled to, or proximate to, a downstream device (such as a collimator 9), and may output a modified laser beam 21 to the downstream device. In this embodiment, the optical assembly 100 includes a single optical aperture 15 and plural beam traps 25. In other embodiments, the optical device 100 may have plural aperture structures and any number of beam traps.

The optical aperture 15, which is illustrated as an annulus shown cross-sectionally, may pass a first portion 21 of the laser beam 5. A remaining portion 22 of the laser beam 5 may be redirected to the beam traps 25. In this embodiment, the optical aperture 15 is a convergent cone that bounces the beam portion 22 across the input path (e.g., uses an acute angle of reflection and/or a convex or concave cone surface) and into the beam dump chambers. In other embodiments, an optical aperture 15 may have a different geometry that may not bounce the beam portion 22 across the input path (e.g., may use an obtuse angle of reflection). A radial dimension of the optical aperture 15 may be selected to define a numerical aperture (NA) of the first portion 21 of the laser beam.

In this embodiment, the beam traps 25 are located in cavities 29 of a region of the housing that may be coupled to (or integrally formed with) a main body region that contains the optical aperture 15, e.g., separate from the beam channel. In other embodiments, a beam trap may be located in the main body, e.g., integrated with the beam channel.

The beam traps 25 may be passively or actively cooled. In one example of passively cooling, cooling fins or some other heat dissipation feature may be located on an exterior the housing to cool the cooling regions receiving the reflected light by natural convection. In an active air cooling example, fans may blow ambient temperature air against the cooling fins or include some other heat dissipation feature (e.g., liquid cooling channels) to increase heat dissipation.

The collimator 9 may be any collimator, now known or later developed. Collimator 9 may not be equipped to handle significant power outside of an optically targeted NA. However, the laser light 21 may have a reduced NA that is within the optically targeted NA of collimator 9. The optical assembly 100 may have an end arranged to couple to the collimator 9, in some embodiments.

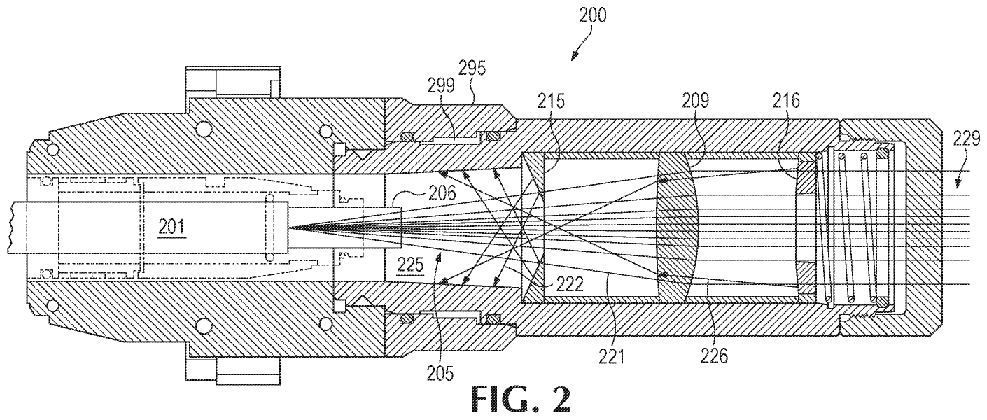

FIG. 2 illustrates a schematic diagram of an optical assembly 200 to modify an NA of a laser beam 205 in which the optical assembly 200 is a collimation assembly, according to various embodiments. The collimation lens 209 is located downstream from the beam trap 225, but in other examples a beam trap may be located downstream from the collimation lens 209. Although the additional function of the optical assembly 200 is to collimate laser light of the input laser beam 205 (to provide the modified collimated laser beam 229 having the different NA) in this example, in other embodiments an optical assembly may have some other additional optical processing function instead of collimation (or in addition to collimation).

The optical assembly 200 includes a first optical aperture 215 upstream of the collimation lens 209 and a second optical aperture 216 downstream of the collimation lens 209. The first optical aperture 215 may be similar in any respect to the optical aperture 15 (FIG. 1). The second optical aperture 216 may reflect light 226 back through the collimation lens 209, which may direct the light 226 across the input path as illustrated.

Optical aperture 216 can be used in isolation when no laser power is expected to intersect the housing body at a downstream location of optical aperture 215 and may be sized according to the application requirements. In other cases, high NA light may impinge on the housing walls before reaching the limiting optical aperture 216. Therefore, the pre-clipping optical aperture 215 may redirect this light back into the cooling region. While optical aperture 215 could provide all the apodization required by the application, the use of two affords optical aperture 215 to be used with multiple focal lengths and with relatively lower tolerances than that of optical aperture 216. Radial dimensions of the optical apertures 215 and 216 may be selected to define an NA of the modified collimated laser beam 229.

A slope of the reflective surface of the optical aperture 216 may be different than the slope of the reflective surface of the optical aperture 215 (e.g., because the laser light received thereon is collimated). In various embodiments an amount of slope of the reflective surface of an optical aperture 216 may be selected to redirect the reflected light to the beam trap 225. In various embodiments, an optical assembly may include any number of optical apertures with different slopes in the range of 0-90 degrees.

In this example, the optical assembly 200 defines a receptacle to couple a distal end of an input fiber 201 to the optical assembly 200. An end cap 206 (a cylindrical glass structure) may be fused to the distal end of the input fiber 201, as illustrated.

Light received in the light trap 225 may transmit heat into an interior surface of the beam dump chamber. The absorbed heat may be carried away to a heat sink by a liquid coolant pumped through coolant channels 299. In this example, the coolant channels 299 are located between an exterior of the beam dump chamber and a clamping structure 295 of the optical assembly 200.

Any laser source described herein may be any fiber laser now known or later developed, or any other laser source now known or later developed. An optic fiber may be used to output, to the optical assembly, laser light generated from any laser source. Some of the optical assemblies described herein may be formed by machining, three dimensional printing, or the like, or combinations thereof.

In view of the many possible embodiments to which the principles of the disclosed technology may be applied, it should be recognized that the illustrated embodiments are only preferred examples and should not be taken as limiting the scope of the disclosure.

1. An optical assembly to process laser light output from a laser source, the optical assembly comprising:
a housing to receive a distal end of an optical fiber that outputs the laser light;
one or more actively cooled or passively cooled beam traps contained within the housing or coupled to the housing; and
one or more optical apertures located inside the housing, at least one of the optical apertures to define a numerical aperture (NA) of a first portion of the laser light based on a radial dimension of the at least one optical aperture, the at least one optical aperture arranged to pass the first portion of the light and redirect a second different portion of the laser light to the one or more actively cooled or passively cooled beam traps.

2. The optical assembly of claim 1, further comprising a collimating lens proximate to the at least one optical aperture.

3. The optical assembly of claim 2, wherein the at least one optical aperture is downstream from the collimating lens, wherein the redirected second portion of the laser light passes through the collimating lens.

4. The optical assembly of claim 2, wherein the at least one optical aperture is upstream from the collimating lens, wherein the redirected second portion of the laser light does not pass through the collimating lens.

5. The optical assembly of claim 1, further comprising a receptacle for coupling the distal end of the optical fiber to the housing.

6. The optical assembly of claim 5, wherein one or more actively cooled or passively cooled beam traps is enclosed by the distal end of the optical fiber.

7. The optical assembly of claim 1, wherein the at least one optical aperture is defined by a convergent cone reflector or a divergent cone reflector.

8. The optical assembly of claim 1, wherein the at least one optical aperture comprises a first optical aperture, wherein the optical assembly further comprises a second optical aperture located inside the housing and downstream from the first optical aperture, the second optical aperture to define an NA of part of the first portion of the laser light based on a radial dimension of the second optical aperture, the second optical aperture arranged to pass the part of the first portion of the light and redirect a different part of the first portion of the laser light to the one or more actively cooled or passively cooled beam traps.

9. The optical assembly of claim 1, wherein the one or more actively cooled or passively cooled beam traps are located in a chamber having an interior surface plated to selectively reflect or absorb the redirected second portion of the laser light.

10. The optical assembly of claim 9, further comprising a heat sink thermally coupled to the interior surface of the chamber, wherein the heat sink is air-cooled or liquid-cooled.

11. An optical assembly to process laser light output from a laser source, the optical assembly comprising:
a housing to receive a distal end of an optical fiber that outputs the laser light;
one or more beam traps contained within the housing or coupled to the housing, the one or more beam traps configured to receive laser light and convert the received laser light to heat;
means for removing the heat from the housing, the heat removal means thermally coupled to the one or more beam traps; and
one or more optical apertures located inside the housing, at least one of the optical apertures to define a numerical aperture (NA) of a first portion of the laser light based on a radial dimension of the at least one optical aperture, the at least one optical aperture arranged to pass the first portion of the light and redirect a second different portion of the laser light to the one or more beam traps,
wherein the laser light received by the one or more beam traps for conversion to heat comprises the redirected second different portion of the laser light.

12. The optical assembly of claim 11, further comprising a collimating lens proximate to the at least one optical aperture.

13. The optical assembly of claim 12, wherein the at least one optical aperture is downstream from the collimating lens, wherein the redirected second portion of the laser light passes through the collimating lens.

14. The optical assembly of claim 12, wherein the at least one optical aperture is upstream from the collimating lens, wherein the redirected second portion of the laser light does not pass through the collimating lens.

15. The optical assembly of claim 11, further comprising means for coupling the distal end of the optical fiber to the housing.

16. The optical assembly of claim 15, wherein one or more beam traps is enclosed by the distal end of the optical fiber.

17. The optical assembly of claim 11, wherein the at least one optical aperture is defined by a convergent cone reflector or a divergent cone reflector.

18. The optical assembly of claim 11, wherein the at least one optical aperture comprises a first optical aperture, wherein the optical assembly further comprises a second optical aperture located inside the housing and downstream from the first optical aperture, the second optical aperture to define an NA of part of the first portion of the laser light based on a radial dimension of the second optical aperture, the second optical aperture arranged to pass the part of the first portion of the light and redirect a different part of the first portion of the laser light to the one or more beam traps, wherein the laser light received by the one or more beam traps for conversion to heat further comprises the redirected part of the second portion of the laser light.

19. The optical assembly of claim 11, wherein the one or more beam traps are located in a chamber having an interior surface plated to selectively reflect or absorb the second portion of the laser light.

20. The optical assembly of claim 19, wherein the heat removal means is thermally coupled to the interior surface of the chamber.
